(19) United States
(12) Patent Application Publication
(10) Pub. No.: US 2006/0158517 A1
(43) Pub. Date: Jul. 20, 2006

(54) SCH phase shift detecting apparatus, color burst signal amplitude detecting apparatus, number of waves detecting apparatus, frequency characteristic controlling apparatus, and SCH phase shift detecting method

(75) Inventors: Yuji Mori, Kawasaki (JP); Yuji Takenaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/376,149

(22) Filed: Mar. 16, 2006

Related U.S. Application Data
(63) Continuation of application No. PCT/JP03/12539, filed on Sep. 30, 2003.

(51) Int. Cl. H04N 17/02; H04N 9/45

(52) U.S. Cl. 348/194; 348/505

(57) ABSTRACT

An SCH phase shift detecting apparatus is disclosed. The SCH phase shift detecting apparatus detects a shift of an SCH phase by using two sample values that have an orthogonal relationship in a color burst signal of a digital composite video signal.

### CROSS-REFERENCE TO RELATED APPLICATION

This application is a U.S. continuation application filed under 35 USC 111(a) claiming benefit under 35 USC 120 and 365(c) of PCT application JP2003/012539, filed Sep. 30, 2003. The foregoing application is hereby incorporated herein by reference.

### BACKGROUND OF THE INVENTION

1. Field of the Invention

The present invention generally relates to an SCH (subcarrier to horizontal) phase shift detecting apparatus, a color burst signal amplitude detecting apparatus, the number of waves detecting apparatus, and a frequency characteristic controlling apparatus in which a shift of an SCH phase, the amplitude of a color burst signal, and the number of waves are detected, and a frequency characteristic is controlled, respectively, by using a digital signal as it is; and an SCH phase shift detecting method in which the shift of the SCH phase is detected.

2. Description of the Related Art

Recently, corresponding to digitization of TV broadcasting, video signals have been changed over from analog signals to digital signals. Consequently, the number of video equipment systems in which an interface for digital video signals is installed has been increasing.

As an interface signal for digital video signals, a digital composite video signal such as an SDI (serial digital interface) signal is known. When monitoring and correcting a horizontal blanking period in the digital video composite signals are performed, a technology of analog video signals such as NTSC (national television system committee) signals is utilized. As a result, when the above monitoring and correcting are performed, analog signals before converting into digital signals or digital signals after converting the analog signals are used.

When the monitoring and the correcting of the horizontal blanking period in the digital video composite signals are performed, a shift θ of an SCH phase in the digital composite video signal must be detected (the SCH phase is described below).

A circuit, which detects phase difference between a received burst signal and an output from an oscillator generating a clock and so on in a digital signal in a receiver, is disclosed {refer to Japanese Patent No. 3118366 (Patent Document 1) and Japanese Patent No. 3304036 (Patent Document 2)}.

FIG. 1 is a block diagram showing a phase difference detecting circuit according to Patent Document 1. As shown in FIG. 1, in the phase difference detecting circuit, a clock pulse, which synchronizes with a horizontal synchronizing signal in a digital composite video signal and has a frequency four times the size of a frequency fsc of a chrominance subcarrier, is selected as a sampling pulse. A color burst signal is sampled from the digital composite video signal, which is sampled by the sampling pulse and converted from an analog signal into a digital signal, in a color burst signal sampling circuit 1. On the other hand, an oscillation signal output from a crystal oscillator 2 oscillating at a frequency of 4 fsc is reduced to a frequency fsc by a frequency divider 3. Further, the phase of the output from the frequency divider 3 is sequentially shifted by 90 degrees by each of phase shifters 4, 5, and 6.

The color burst signal sampled in the color burst signal sampling circuit 1 is sent to four S/Hs (sample holding circuits) 7, 8, 9, and 10 and held along with outputs from the frequency divider 3, the phase shifters 4, 5, and 6, respectively, as sampling pulses. An output from the sample holding circuit 9 is subtracted from an output from the sample holding circuit 7 by an adder 11, and the subtracted result is registered in a register 12 by being supplied from the adder 11. Outputs from the register 12 are accumulated in the adder 11 by the number of times which equals the number of color burst waves or less during a horizontal scanning period. An output from the sample holding circuit 10 is subtracted from an output from the sample holding circuit 8 by an adder 14, and the subtracted result is registered in a register 15 by being supplied from the adder 14. Outputs from the register 15 are accumulated in the adder 14 by the number of times which equals the number of color burst waves or less during a horizontal scanning period.

The accumulated value in the register 12 is divided by the accumulated value in the register 15 by a divider 17. When phase difference between the output from the frequency divider 3 and the color burst signal is defined as θ, a value corresponding to tan θ is output from the divider 17.

FIG. 2 is a block diagram showing a video signal processing apparatus including a phase difference detecting circuit according to Patent Document 2. In the video signal processing apparatus using for a digital TV receiver shown in FIG. 2, an A/D (analog to digital) converter 22 is connected to an input analog composite video signal via a clamping circuit 21. The A/D converter 22 converts the analog composite video signal clamped by the clamping circuit 21 into a digital composite video signal by applying sampling corresponding to an internal clock signal (sampling clock signal). The digital composite video signal digitized by the A/D converter 22 is supplied to a Y/C separation circuit 23. A digital color signal from the Y/C separation circuit 23 is supplied to a color phase demodulator 24. The color phase demodulator 24 is composed of multipliers 25 and 26 and LPFs (low-pass filters) 27 and 28. An R-Y red chrominance signal is obtained by the multiplier 25 and the LPF 27, and a B-Y blue chrominance signal is obtained by the multiplier 26 and the LPF 28.

The R-Y signal and the B-Y signal are supplied to a burst phase detector 29. The burst phase detector 29 provides a divider 30 and an arc tangent operator 31, and generates a color burst phase difference signal from the R-Y signal and the B-Y signal during a color burst period.

However, in Patent Documents 1 and 2, the phase difference between an output signal of an oscillator generating a clock and so on in a receiver and a received burst signal is detected in the receiver, and detection of a shift of an SCH phase, which is an object of the present invention, cannot be performed.

In conventional technologies including Patent Documents 1 and 2, when the digital composite video signals (SDI signals) are used as they are, detection of a shift of a SCH phase, detection of amplitude of a color burst signal, and detection of the number of waves of the color burst signal cannot be performed.

In addition, in Patent Document 1, four sample values are used and accumulation of the number of times of the number of waves or less is performed; that is, these operations are complex. Further, in Patent Document 2, two different chrominance signals are used; consequently, the circuit structure becomes complex.

### SUMMARY OF THE INVENTION

Accordingly, the present invention may provide an SCH phase shift detecting apparatus, a color burst signal amplitude detecting apparatus, the number of waves detecting apparatus, and a frequency characteristic controlling apparatus in which a shift of an SCH phase, the amplitude of a color burst signal, and the number of color burst waves are detected, and a frequency characteristic of a digital composite video signal is controlled, respectively, with a simple structure by using the digital composite video signal as it is; and an SCH phase shift detecting method in which the shift of the SCH phase is detected.

According to an aspect of the present invention, there is provided an SCH phase shift detecting apparatus which detects a shift of an SCH phase by using two sample values that have an orthogonal relationship in a color burst signal of a digital composite video signal.

Since the shift of the SCH phase can be detected by using two sample values that have an orthogonal relationship in the color burst signal of the digital composite video signal, the SCH phase shift detecting apparatus can be provided with a simple structure by using the digital composite video signal as it is.

According to another aspect of the present invention, there is provided a color burst signal amplitude detecting apparatus which detects an amplitude value of a color burst signal by using one sample value of the color burst signal of a digital composite video signal and data of a shift of an SCH phase.

Since the amplitude value of the color burst signal can be detected by using one sample value of the color burst signal of the digital composite video signal and data of the shift of the SCH phase, the color burst signal amplitude detecting apparatus can be provided with a simple structure by using the digital composite video signal as it is.

According to another aspect of the present invention, there is provided the number of waves detecting apparatus which detects the number of waves of a color burst signal by comparing the amplitude value of the color burst signal detected by the color burst signal amplitude detecting apparatus with a predetermined value.

Since the number of waves of the color burst signal can be detected by comparing the amplitude value of the color burst signal detected by the color burst signal amplitude detecting apparatus with a predetermined value, the number of waves detecting apparatus can be provided with a simple structure by using the digital composite video signal as it is.

According to another aspect of the present invention, there is provided a frequency characteristic controlling apparatus which controls a frequency characteristic of a digital composite video signal by using a ratio of the amplitude value of the color burst signal detected by the color burst signal amplitude detecting apparatus to an amplitude value of a horizontal synchronizing signal.

Since the frequency characteristic of the digital composite video signal can be controlled by using the ratio of the amplitude value of the color burst signal detected by the color burst signal amplitude detecting apparatus to the amplitude value of a horizontal synchronizing signal, the frequency characteristic controlling apparatus can be provided with a simple structure by using the digital composite video signal as it is.

According to another aspect of the present invention, there is provided an SCH phase shift detecting method which detects a shift of an SCH phase by using two sample values that have an orthogonal relationship in a color burst signal of a digital composite video signal.

Since the shift of the SCH phase can be detected by using two sample values that have an orthogonal relationship in the color burst signal of the digital composite video signal, the SCH phase shift detecting method can be provided with a simple structure by using the digital composite video signal as it is.

### BRIEF DESCRIPTION OF THE DRAWINGS

Other objects and further features of the present invention will be apparent from the following detailed description when read in conjunction with the accompanying drawings.

FIG. 1 is a block diagram showing a phase difference detecting circuit according to a conventional technology;

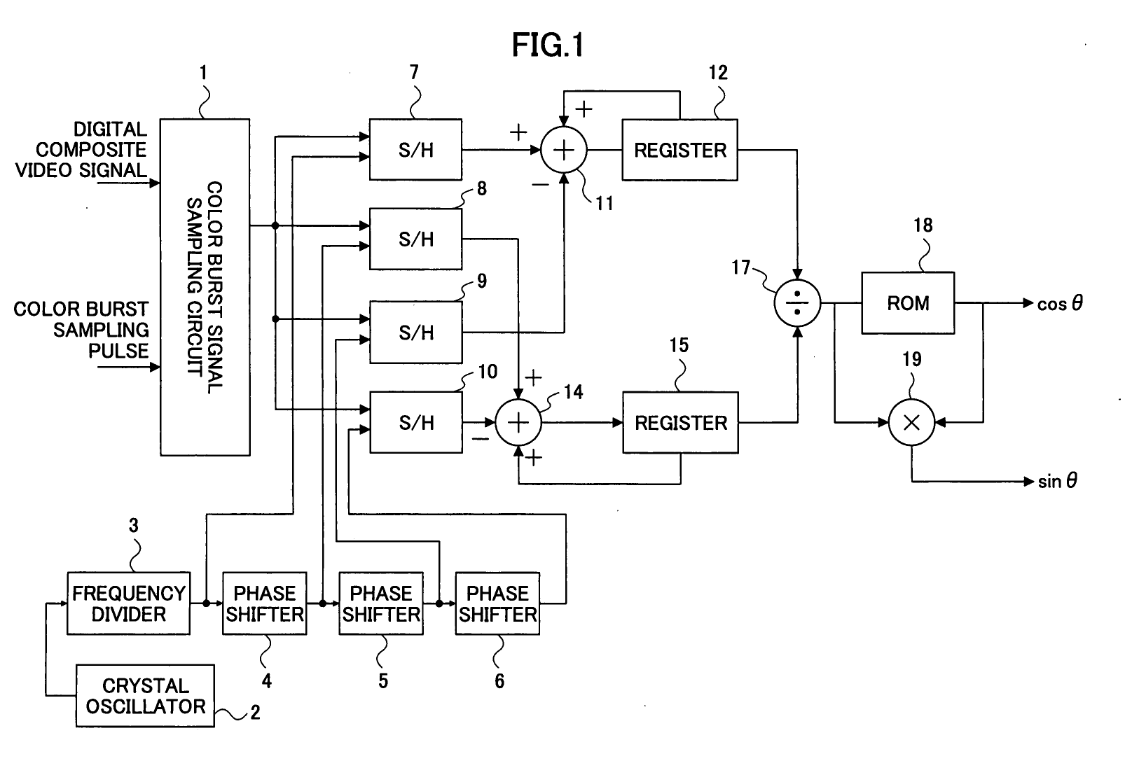

FIG. 2 is a block diagram showing a video signal processing apparatus including a phase difference detecting circuit according to another conventional technology;

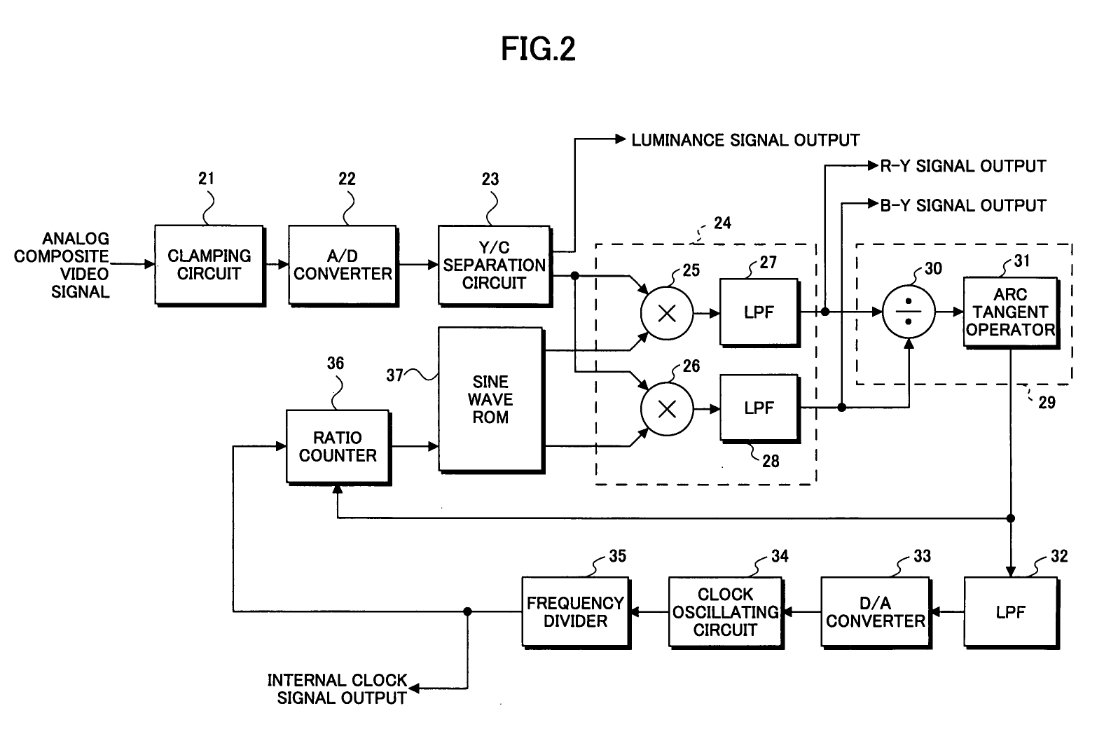

FIG. 3 is a diagram explaining an SCH phase;

FIG. 4 is a diagram explaining sample positions and values of bit samples during a digital horizontal blanking period;

FIG. 5 is a diagram showing a color burst signal in a case of an odd field and an odd line and an even field and an even line;

FIG. 6 is a diagram showing the color burst signal in a case of an odd field and an even line and an even field and an odd line;

FIG. 7 is a block diagram showing an apparatus in which a shift of an SCH phase is detected, amplitude of a color burst signal is detected, the number of waves of a color burst signal is detected, and a frequency characteristic is controlled according to an embodiment of the present invention; and

FIG. 8 is a block diagram showing a control signal block shown in FIG. 7 in detail.

### DESCRIPTION OF THE PREFERRED EMBODIMENT

Referring to the drawings, an embodiment of the present invention is explained.

### Operational Principle

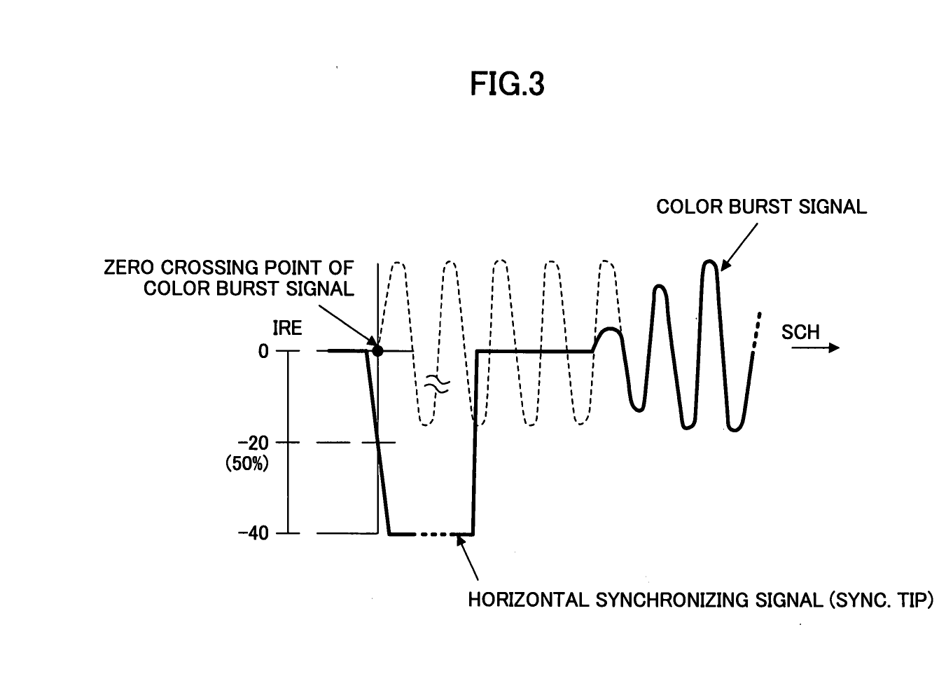

FIG. 3 is a diagram explaining an SCH phase. The SCH phase is a phase such as in an SDI digital composite video signal. Referring to FIG. 3, the SCH phase is explained. The SDI digital composite video signal is a studio digital interface signal and a digital video signal for intra-office transmission. The SDI digital composite video signal is also used for intra-office transmission. A general viewer can watch a digital broadcasting program broadcast by using the SDI digital composite video signal on a digital TV receiver.

In an NTSC signal, two color signals E_{I} and E_{Q} are transmitted so that a right angle two-phase modulation is applied to a chrominance subcarrier. Therefore, a frequency and a phase of a local subcarrier for detection of a receiver must have a right relationship with those of a subcarrier of a transmitter. In order to meet this, in the NTSC system, a color burst signal is transmitted. The color burst signal is inserted in a back porch of a horizontal synchronizing signal and is a subcarrier which is maintained in 8 to 12 cycles whose amplitude is a pp value equal to that of the horizontal synchronizing signal.

As shown in FIG. 3, in the SCH phase of the NTSC signal, a zero crossing point of a color burst signal is equal to a front edge position of 50% amplitude of a horizontal synchronizing signal (pulse) when the color burst signal is extended to the horizontal synchronizing signal. In the SMPTE (Society of Motion Picture and Television Engineers)-170M standard stipulating the SCH phase, the error is stipulated to be within 0±10 degrees.

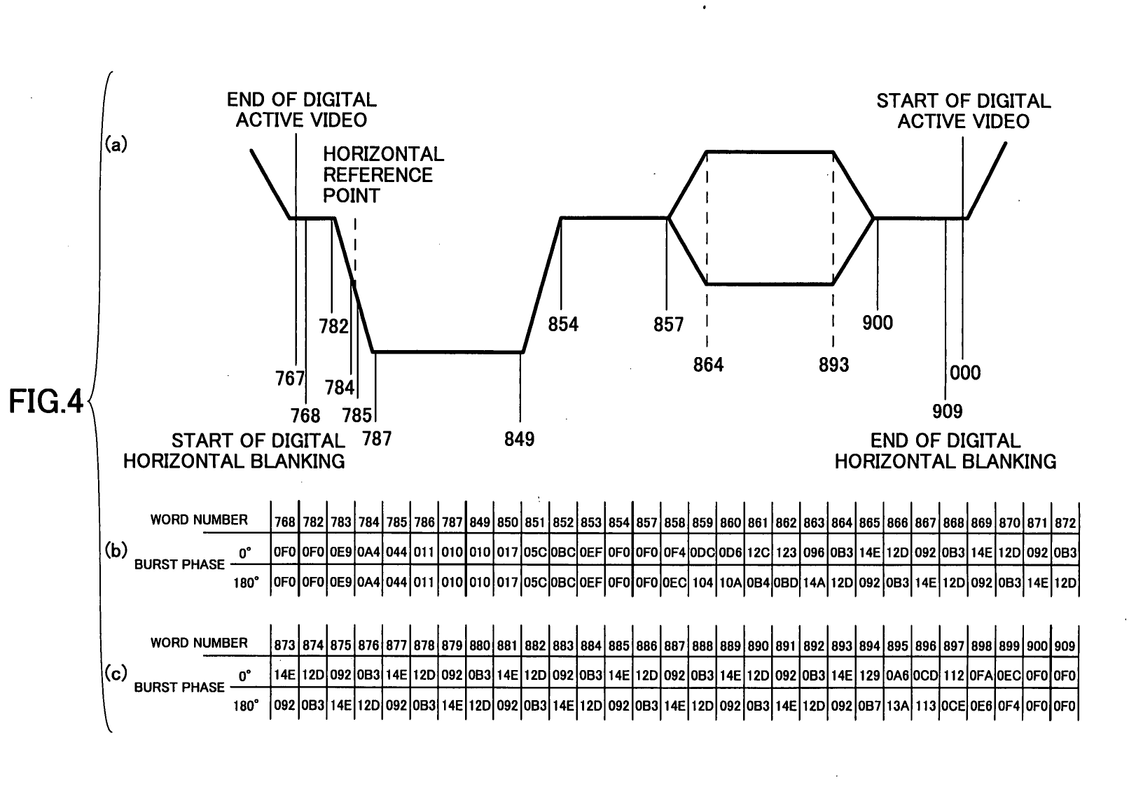

FIG. 4 is a diagram explaining sample positions and values of bit samples during a digital horizontal blanking period. The digital composite video signal has a sampling clock rate four times (4 fsc=4×3.579545 MHz) the frequency fsc of a chrominance subcarrier of an analog NTSC signal. A sample value in a horizontal blanking period is stipulated in SMPTE-244 as a parallel interface of a composite signal. Therefore, a sampling interval in a color burst part is just 90 degrees in the phase difference.

In FIG. 4, the sample position is shown by a word number. As shown in FIG. 4 (a), the word number at the start of digital active video is defined as “000” and the word number at the end of digital horizontal blanking is defined as “909”. Therefore, sampling is performed 910 times in one horizontal period.

As shown in FIG. 4 (a), the word number of the start of the digital active video is “000”, the word number of the end of the digital active video is “767”, a front porch is sampled at the word numbers from “768” to “782”, a horizontal synchronizing signal part is sampled at the word numbers from “782” to “854”, and a back porch is sampled at the word numbers from “854” to “909”. A color burst part is sampled at the word numbers from “857” to “900”. In this, a TRS-ID (described below), which is a line unique word, exists at the word numbers from “790” to “794”.

The sample values are shown in FIG. 4 (b) and (c) as 10-bit expressions. However, the sample values can be shown as 8-bit expressions instead of the 10-bit expressions. Since the color burst signal is inverted every line and every field, values in cases where ωt is 0° and 180° are shown.

In addition, the pedestal level is shown as “0F0”. A color burst signal of an ideal SCH phase 0° is shown by equation (1).
a=A sin (ωt−33°) (1)
Then, a color burst signal of a phase shift θ is shown by equation (2).
a=A sin (ωt−33°−θ) (2)

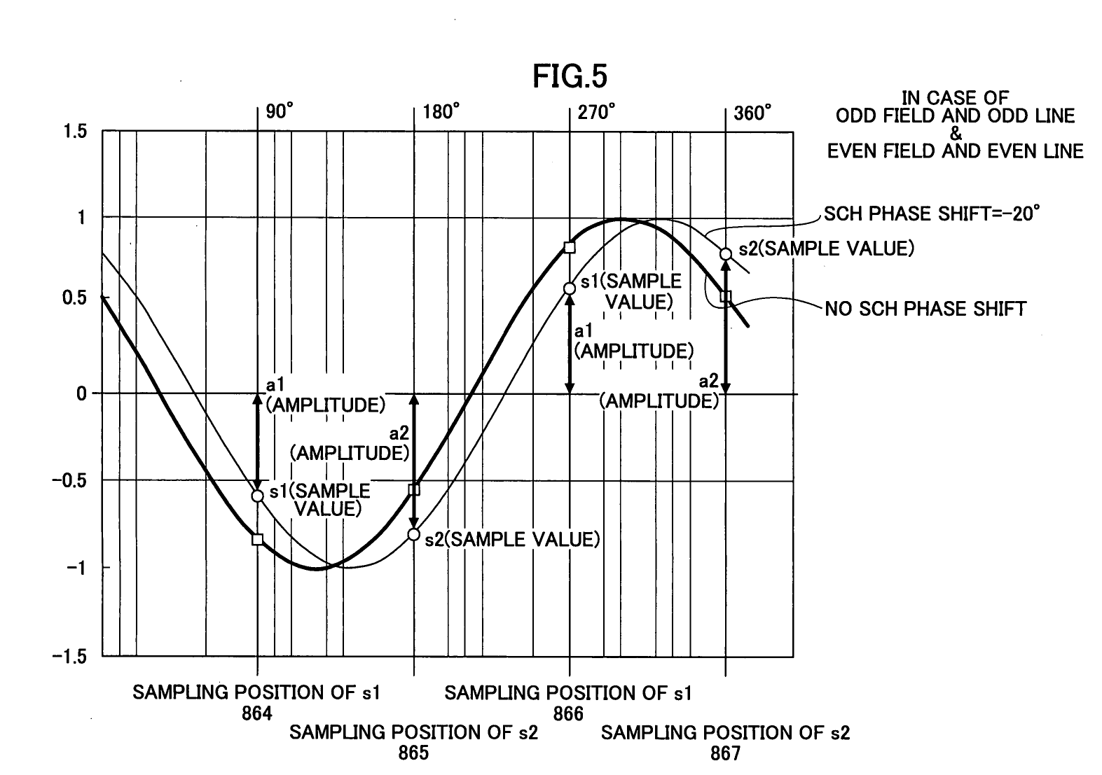

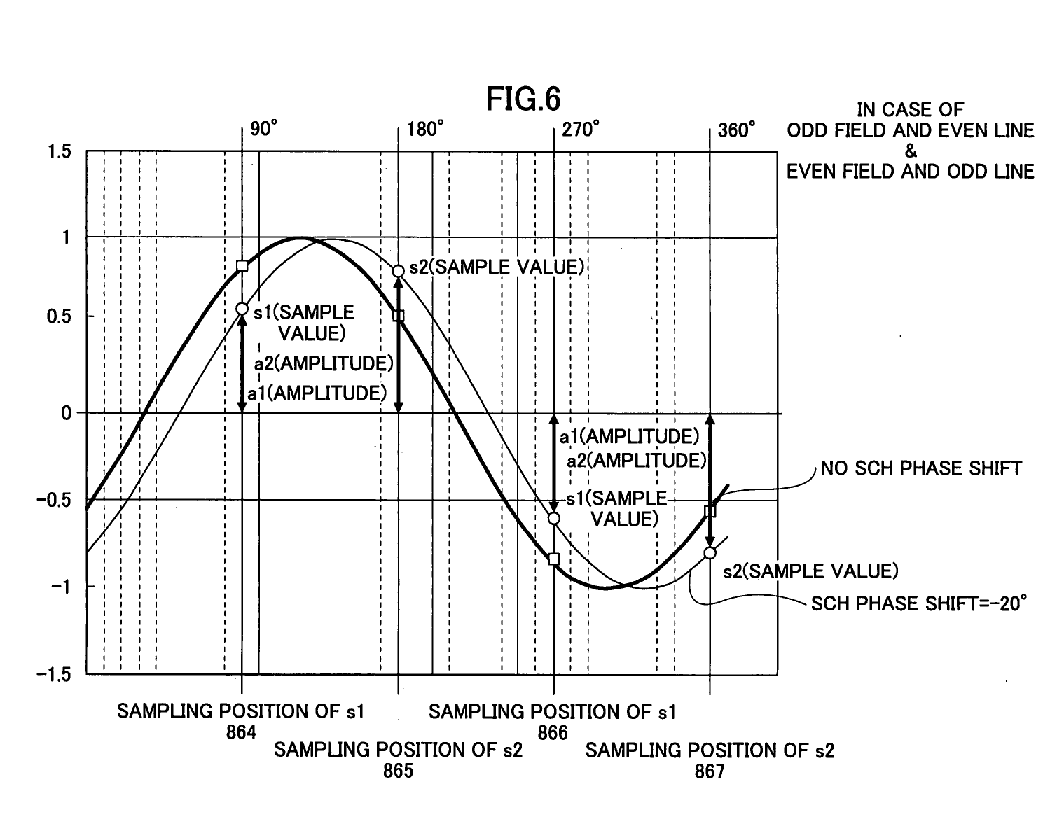

FIG. 5 is a diagram showing a color burst signal sampled at the word numbers from “864” to “867” in a case of an odd field and an odd line and an even field and an even line. FIG. 6 is a diagram showing a color burst signal sampled at the word numbers from “864” to “867” in a case of an odd field and an even line and an even field and an odd line. The principle is the same in FIGS. 5 and 6. Therefore, the case shown in FIG. 5 is explained. In FIGS. 5 and 6, since the color burst signal is sampled by 4 fsc, the interval between samples is 90°.

In FIG. 5, the sample value at the word number “864” whose phase is 90° is shown by “s1”, and the amplitude at this time is shown by “a1”. Since the color burst signal is a sine wave, the sample value whose phase is 270° at the word number “866” becomes the same “s1” and the amplitude at that time also becomes the same “a1”.

In addition, the sample value at the word number “865” whose phase is 180° is shown by “s2”, and the amplitude at this time is shown by “a2”. Since the color burst signal is a sine wave, the sample value whose phase is 360° at the word number “867” becomes the same “s2” and the amplitude at that time also becomes the same “a2”.

### Detection of Shift θ of SCH Phase

Since the color burst signal is a sine wave in which the pedestal level “0F0” (hex) is the center, the amplitude at the sample point of the color burst signal is a value resulting when “0F0” (hex) is subtracted from the sample value “s1” or “s2”.

That is, the amplitude “a1” and “a2” of the color burst signal are shown in equations (3) and (4).
a1=s1−0F0 (hex) (3)
a2=s2−0F0 (hex) (4)

Since the color burst signal of the phase shift θ is shown by equation (2), the amplitude “a1” of the color burst signal is shown by equation (5), and the amplitude “a2” of the color burst signal is shown by equation (6).

$$\begin{matrix}\begin{matrix}a 1 = A sin ( 90 - ( {33}^{∘} + θ ) ) \\ = A cos ( {33}^{∘} + θ )\end{matrix} & ( 5 ) \\ \begin{matrix}a 2 = A sin ( 180 - ( {33}^{∘} + θ ) ) \\ = A sin ( {33}^{∘} + θ )\end{matrix} & ( 6 )\end{matrix}$$

Therefore, from equations (5) and (6), equation (7) is obtained.
a2/a1=tan (33°+θ) (7)

From equation (7), the shift θ of the SCH phase can be obtained by equation (8).
θ=tan⁻¹ (a2/a1)−33° (8)

When equations (3) and (4) are substituted in equation (8), the shift θ of the SCH phase can be shown by equation (9).
θ=tan⁻¹ ((s2−0F0 (hex))/(s1−0F0 (hex)))−33° (9)

From equation (9), the shift θ of the SCH phase can be obtained by the two sample values “s1” and “s2” having an orthogonal relationship in the color burst signal.

### Detection of Amplitude A of Color Burst Signal

When the shift of the SCH phase is defined as θ, the amplitude of the color burst signal is defined as A, the amplitude of the color burst signal at a sample point is defined as “a”, and the sample value of the color burst signal is defined as “s”, the amplitude “a” at the sample point is shown by equation (10) by using equation (2).

$$\begin{matrix}a = A sin ( ω t - {33}^{∘} - θ ) & ( 2 ) \\ = A sin ( ω t - ( {33}^{∘} + θ ) ) & ( 10 )\end{matrix}$$

Therefore, the amplitude A of the color burst signal is shown by equations (11) and (12).

$$\begin{matrix}A = a / ( sin ( ω t - ( {33}^{∘} + θ ) ) ) & ( 11 ) \\ = ( s - 0 F 0 ( hex ) ) / ( sin ( ω t - ( {33}^{∘} + θ ) ) ) & ( 12 )\end{matrix}$$

Similarly, in cases where ωt is 90° and 270°, the amplitude A of the color burst signal is shown by equations (13) and (14).

$$\begin{matrix}A = ( s 1 - 0 F 0 ( hex ) ) / ( sin ( 90 - ( {33}^{∘} + θ ) ) ) \\ = ( s 1 - 0 F 0 ( hex ) ) / ( cos ( {33}^{∘} + θ ) )\end{matrix} \qquad ( 13 )$$

(14)

From equation (14), the amplitude A of the color burst signal can be obtained by the one sample value “s1” of the color burst signal part of the digital composite video signal and data of the shift θ of the SCH phase.

### Embodiment

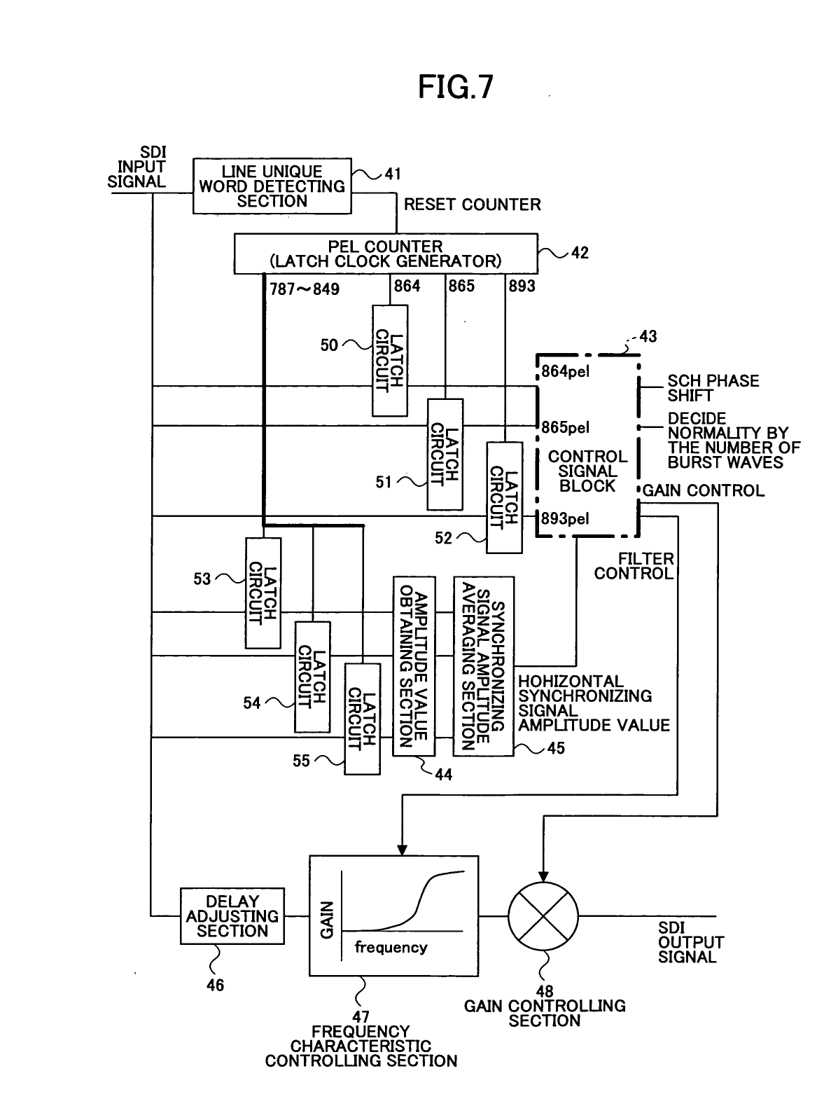

FIG. 7 is a block diagram showing an apparatus in which a shift of an SCH phase is detected, amplitude of a color burst signal is detected, the number of waves of the color burst signal is detected, and a frequency characteristic is controlled according to an embodiment of the present invention. Referring to FIG. 7, the structure of the apparatus is explained.

The apparatus according to the embodiment of the present invention provides a line unique word detecting section 41, a pel counter (latch clock generator) 42, a control signal block 43, an amplitude value obtaining section 44, a synchronizing signal amplitude averaging section 45, a delay adjusting section 46, a frequency characteristic controlling section 47, a gain controlling section 48, and latch circuits 50 through 55.

The line unique word detecting section 41 detects TRS-IDs existing in the word numbers from “790” through “794” of a digital composite video signal (SDI signal) and resets the pel counter 42.

The pel counter 42 counts pels and generates a latch clock at timing of a pel number corresponding to the word number, and supplies the latch clock to the latch circuits 50 through 55. The latch circuits 50 through 55 latch an SDI signal corresponding to a predetermined word number, based on the latch clock from the pel counter 42. For example, the latch circuit 50 latches a sample value of the word number “864”, the latch circuit 51 latches a sample value of the word number “865”, the latch circuit 52 latches a sample value of the word number “893”, and the latch circuit 53 latches a sample value of the word number “787”.

In the latch circuits 53, 54, and 55, data of the word number “787”, the word number “788”, . . . , and the word number “849”, respectively, corresponding to a horizontal synchronization base are latched. The amplitude value obtaining section 44 calculates differences (corresponding to amplitude of a horizontal synchronizing signal) between each data value “s” of the word number “787”, the word number “788”, . . . , and the word number “849” and a data value of the pedestal level (0F0 (hex)), and outputs amplitude “a” at each sample point. The synchronizing signal amplitude averaging section 45 calculates an average value of amplitude “a” at each sample point in the word number “787”, the word number “788”, . . . , and the word number “849”, and outputs the averaged horizontal synchronizing signal amplitude value. The averaged horizontal synchronizing signal amplitude value is supplied to the control signal block 43.

In addition, data of the word number “864” corresponding to the color burst signal are latched in the latch circuit 50, data of the word number “865” corresponding to the color burst signal are latched in the latch circuit 51, and data of the word number “893” corresponding to the color burst signal are latched in the latch circuit 52.

As shown in equation (9), the shift θ of the SCH phase can be obtained by two sample values “s1” and “s2”. Therefore, the control signal block 43 obtains the shift θ of the SCH phase based on adjacent data of the color burst signals latched by the latch circuits 50, 51, and 52 by using equation (9).

In addition, the control signal block 43 controls the gain controlling section 48 by using the amplitude value of the horizontal synchronizing signal calculated at the synchronizing signal amplitude averaging section 45.

Since the horizontal synchronizing signal is a low frequency compared with the color burst signal, and the color burst signal is a high frequency compared with the horizontal synchronizing signal, when the amplitude value of the horizontal synchronizing signal is larger than that of the color burst signal by comparing them, it is considered that the high frequency region of the SDI digital composite video signal is attenuated. Therefore, the control signal block 43 increases the high frequency region of the SDI digital composite video signal by controlling the frequency characteristic controlling section 47. Consequently, the frequency characteristic of the SDI digital composite video signal in the high frequency region is emphasized.

The control signal block 43 calculates the number of burst cycles having predetermined amplitude or more. The number of burst cycles having the predetermined amplitude or more can be calculated from a detected color burst value, or can be calculated by normalizing the detected color burst value.

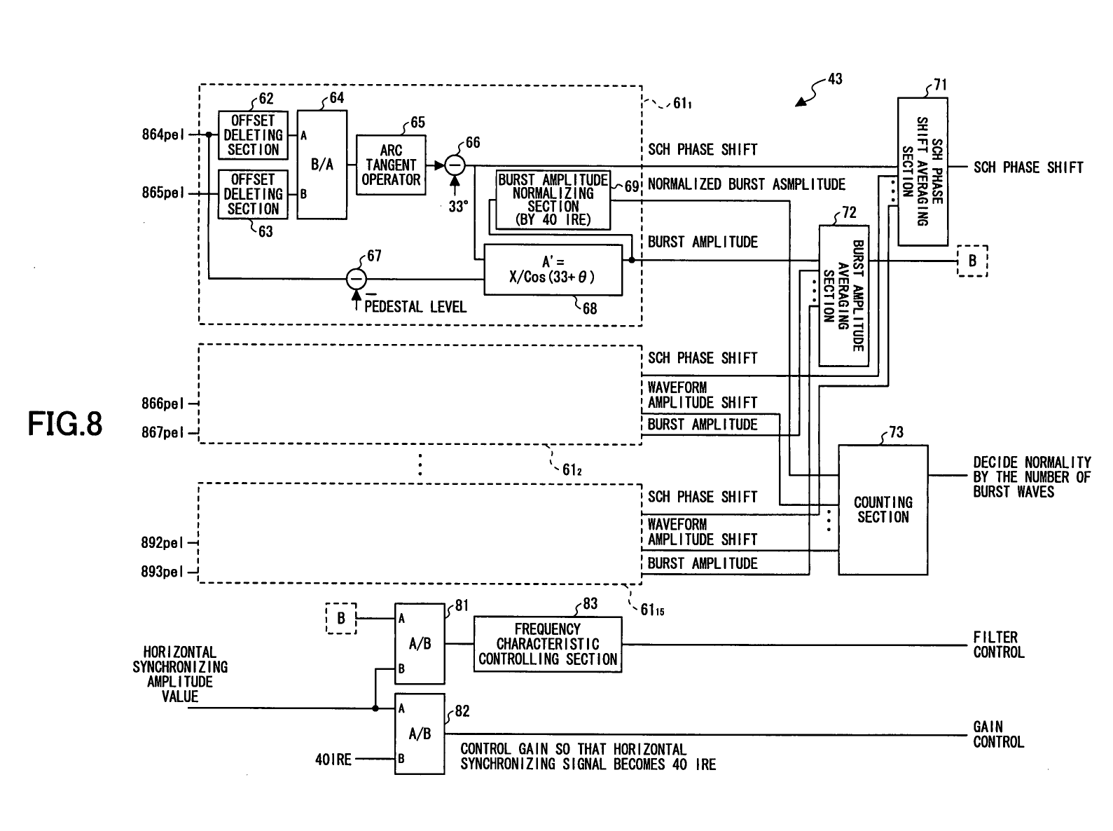

FIG. 8 is a block diagram showing the control signal block 43 shown in FIG. 7 in detail. The control signal block 43 provides burst signal processing sections 61₁ through 61₁₅, an SCH phase shift averaging section 71, a burst amplitude averaging section 72, a counting section 73, dividers 81 and 82, and a frequency characteristic controlling section 83. Each of the burst signal processing sections 61₁ through 61₁₅ includes offset deleting sections 62 and 63, a divider 64, an arc tangent operator 65, subtractors 66 and 67, a burst signal amplitude operator 68, and a burst amplitude normalizing section 69.

Data of 864 pel and data of 865 pel in the color burst signal are supplied to the burst signal processing section 61₁. As described in the operational principle, the data of 864 pel correspond to “s1” and the data of 865 pel correspond to “s2”.

An operation of equation (3) is performed for the data of 864 pel (s1) at the offset deleting section 62 and the subtraction of the pedestal level “0F0” is performed, and an operation of equation (4) is performed for the data of 865 pel (s2) at the offset deleting section 63 and the subtraction of the pedestal level “0F0” is performed. Outputs “a1” and “a2” from the offset deleting sections 62 and 63 are supplied to the divider 64. An operation of equation (7) is performed at the divider 64. An output from the divider 64 is supplied to the arc tangent operator 65 and the subtractor 66 via the arc tangent operator 65. An operation of equation (8) is performed at the arc tangent operator 65 and the subtractor 66, then, a shift θ of the SCH phase can be obtained from the subtractor 66.

The data of 864 pel (s1) and the pedestal level “0F0” are supplied to the subtractor 67. An operation of equation (3) is performed at the subtractor 67, and the subtraction of the pedestal level “0F0” from the “s1” is performed. The output (the shift θ of the SCH phase) from the subtractor 66 and the output (a1) from the subtractor 67 are supplied to the burst signal amplitude operator 68. An operation of equation (14) is performed at the burst signal amplitude operator 68, and an amplitude value of the burst signal can be obtained from the burst signal amplitude operator 68. The burst amplitude (amplitude value) of the burst signal obtained from the burst signal amplitude operator 68 is supplied to the burst amplitude normalizing section 69 and the burst amplitude averaging section 72.

The burst amplitude normalizing section 69 normalizes the amplitude value of the burst signal supplied from the burst signal amplitude operator 68 by using 40 IRE (burst amplitude). That is, when the amplitude value of the burst signal supplied from the burst signal amplitude operator 68 is equal to 40 IRE (burst amplitude), the burst amplitude becomes “1”, and when the amplitude value is less than 40 IRE (burst amplitude), the burst amplitude becomes a value less than “1”. Data of the burst amplitude normalized at the burst amplitude normalizing section 69 are supplied to the counting section 73.

Data of 866 pel and 867 pel in the color burst signal are supplied to the burst signal processing section 61₂. Similar to the burst signal processing section 61₁, from the burst signal processing section 61₂, a shift θ of the SCH phase, data of normalized burst amplitude, and burst amplitude are output, corresponding to the data of 866 pel and 867 pel.

Similarly, data of 892 pel and 893 pel in the color burst signal are supplied to the burst signal processing section 61₁₅. Similar to the burst signal processing section 61₂, from the burst signal processing section 61₁₅, a shift θ of the SCH phase, data of normalized burst amplitude, and burst amplitude are output, corresponding to the data of 892 pel and 893 pel.

The SCH phase shift averaging section 71 averages the shifts θ of the SCH phases received from the burst signal processing sections 61₁ through 61₁₅, and an output from the SCH phase shift averaging section 71 becomes the shift θ of the SCH phase which is calculated at the control signal block 43.

The burst amplitude averaging section 72 averages the data of the burst amplitude received from the burst signal processing sections 61₁ through 61₁₅, and an output from the burst amplitude averaging section 72 is supplied to the divider 81.

The counting section 73 counts the number of data whose value is a threshold or more by receiving data of the normalized burst amplitude from the burst signal processing sections 61₁ through 61₁₅. For example, when the threshold equals 0.9, the data elements whose value is 0.9 or more are counted and the number of data elements is defined as the number of burst waves, and the normality of the color burst data is decided based on the number of burst waves.

The divider 81 obtains a ratio of the output from the burst amplitude averaging section 72 (averaged data of 15 calculated results of the “864” to “893” words) to the horizontal synchronizing amplitude value. The divider 81 controls the frequency characteristic controlling section 83 corresponding to the ratio. For example, when an output from the divider 81 is “1”, the divider 81 controls the frequency characteristic controlling section 83 so that the frequency becomes flat, and when the output from the divider is less than “1”, the divider 81 controls the frequency characteristic controlling section 83 (the frequency characteristic controlling section 47 shown in FIG. 7) to raise the high frequency region due to the fall of the high frequency region.

The divider 82 obtains a ratio of the horizontal synchronizing signal to 40 IRE (normal horizontal synchronizing amplitude value) and exerts control so that the gain becomes 40 IRE.

As described above, according to the embodiment of the present invention, an SCH phase shift detecting apparatus, a color burst signal amplitude detecting apparatus, the number of waves detecting apparatus, and a frequency characteristic controlling apparatus are provided, in which a shift of an SCH phase, the amplitude of a color burst signal, and the number of color burst waves are detected. In addition, a frequency characteristic of digital composite video signals is controlled with a simple structure by using the digital composite video signal as it is. Further, an SCH phase shift detecting method in which a shift of an SCH phase is detected is provided.

Further, the present invention is not limited to the embodiment, but various variations and modifications may be made without departing from the scope of the present invention.

What is claimed is:

1. An SCH phase shift detecting apparatus which detects a shift of an SCH phase by using two sample values that have an orthogonal relationship in a color burst signal of a digital composite video signal.

2. A color burst signal amplitude detecting apparatus which detects an amplitude value of the color burst signal by using one sample value of a color burst signal of a digital composite video signal and data of a shift of an SCH phase.

3. The number of waves detecting apparatus which detects the number of waves of a color burst signal by comparing the amplitude value of the color burst signal detected by the color burst signal amplitude detecting apparatus as claimed in claim 2 with a predetermined value.

4. A frequency characteristic controlling apparatus which controls a frequency characteristic of a digital composite video signal by using a ratio of the amplitude value of the color burst signal detected by the color burst signal amplitude detecting apparatus as claimed in claim 2 to an amplitude value of a horizontal synchronizing signal.

5. An SCH phase shift detecting method which detects a shift of an SCH phase by using two sample values that have an orthogonal relationship in a color burst signal of a digital composite video signal.

6. A color burst signal amplitude detecting method which detects an amplitude value of a color burst signal by using one sample value of a color burst signal of a digital composite video signal and data of a shift of an SCH phase.

7. The number of waves detecting method which detects the number of waves of a color burst signal by comparing the amplitude value of the color burst signal detected by the color burst signal amplitude detecting method as claimed in claim 6 with a predetermined value.

8. A frequency characteristic controlling method which controls a frequency characteristic of a digital composite video signal by using a ratio of the amplitude value of the color burst signal detected by the color burst signal amplitude detecting method as claimed in claim 6 to an amplitude value of a horizontal synchronizing signal.
